(19) United States
(12) Patent Application Publication
(10) Pub. No.: US 2017/0262915 A1
(43) Pub. Date: Sep. 14, 2017

(54) CUSTOMIZED FOOD AND RECIPE ORDERING, PRODUCTION, LABELING, AND DELIVERY SYSTEM AND METHOD OF USE

(71) Applicant: Christine M. Sanders, Kansas City, MO (US)

(72) Inventor: Christine M. Sanders, Kansas City, MO (US)

(21) Appl. No.: 15/453,533

(22) Filed: Mar. 8, 2017

Related U.S. Application Data
(60) Provisional application No. 62/305,897, filed on Mar. 9, 2016.

(51) Int. Cl. G06Q 30/06; G06Q 50/12; G06Q 10/08; G06F 17/30

(52) U.S. Cl. CPC G06Q 30/0621; G06Q 30/0633; G06F 17/30312; G06Q 50/12; G06Q 10/083

(57) ABSTRACT

An interactive and customizable food delivery system with a high degree of personalization. The system provides for the personalization of a product and product label thereby delivering a client-specified food product based upon their recipe input through a computer device interface. Through use of a computer interface, such as a mobile computing device or “smart phone,” personal computer, or even through a unique computerized kiosk located at a fixed location, the user can input recipes or order products from existing recipes. The product is prepared either locally or remotely and is then delivered or shipped to the user with a customized label indicating ingredients and other information.

### CROSS REFERENCE TO RELATED APPLICATION

This application claims priority in U.S. Provisional Patent Application No. 62/305,897, filed Mar. 9, 2016, which is incorporated herein by reference.

### BACKGROUND OF THE INVENTION

1. Field of the Invention

The present invention relates generally to a food processing and delivery system and method for use thereof, and more specifically to a self-contained, customizable and personalized food delivery system and method of use thereof.

2. Description of the Related Art

Most households in America are faced with the continuous challenge of teaching their kids to make good decisions about food choice. This active conversation between parents and children can often lead to arguments and ultimately feelings of discord which can become part of a very negative dialogue for most families. As a result, there is not only valuable time lost for families associated with this tension, but also a true financial cost due to food waste and non-nutritious food intake. Beyond the emotional issues associated with healthy food choices, families are also facing rising expenses associated with food.

This problem or challenge most certainly exists globally, ultimately presenting an opportunity for an international revenue model, but the early scope of the business concept is to remain focused on the approximately 40 million households which participate in the production and/or consumption of garden-raised, home-canned goods.

What is needed is a system providing easily customizable and personalized food options which can be entirely produced, labeled, and delivered at a single point. Food items can be produced by qualified households, food manufacturers or other qualified market participants.

Heretofore there has not been available a system or method for a customizable food and recipe delivery system with the advantages and features of the present invention.

### BRIEF SUMMARY OF THE INVENTION

The present invention generally provides an interactive and customizable food delivery system with a high degree of personalization. The system provides for the personalization of a product and product label thereby delivering a client-specified food product based upon their recipe input through a computer device interface. Through use of a computer interface, such as a mobile computing device or “smart phone,” personal computer, or even through a unique computerized kiosk located at a fixed location, the user can input recipes or order products from existing recipes. The product is prepared either locally or remotely and is then delivered or shipped to the user with a customized label indicating ingredients and other information.

Benefits of the present invention include, but are not limited to: (1) customized recipe generation resulting from an interaction system; (2) personalized, home-preserved goods which can be labeled; (3) facilitation of produce and home-preserved goods exchanged in an exclusive web environment with a variety of qualified market participants—expert households, food manufacturers, community gardens, community kitchens, buying institutions; and (4) educational processes and information for food preservation.

### BRIEF DESCRIPTION OF THE DRAWINGS

The drawings constitute a part of this specification and include exemplary embodiments of the present invention illustrating various objects and features thereof.

FIG. 1 is a diagrammatic representation showing the relationship between several elements of the present invention.

FIG. 2 is another diagrammatic representation showing the relationship between elements of the present invention.

FIG. 3 is yet another diagrammatic representation showing the relationship between elements of the present invention.

FIG. 4 is a diagrammatic representation of an interactive kiosk element of an embodiment of the present invention.

FIG. 5 is a flowchart diagramming steps taken in practicing an embodiment of the present invention.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning. Additional examples include computing devices such as a mobile smart device including a display device for viewing a typical web browser or user interface will be commonly referred to throughout the following description. The type of device, computer, display, or user interface may vary when practicing an embodiment of the present invention. A computing device could be represented by a desktop personal computer, a laptop computer, “smart” mobile phones, PDAs, tablets, or other handheld computing devices. The computing device could be included in a stand-alone kiosk which is electrically communicating with a local or remote system for producing, exchanging or gifting and in some instances selling customized and/or personalized garden and preserved food goods or other final products.

### II. Preferred Embodiment Product Delivery System 2

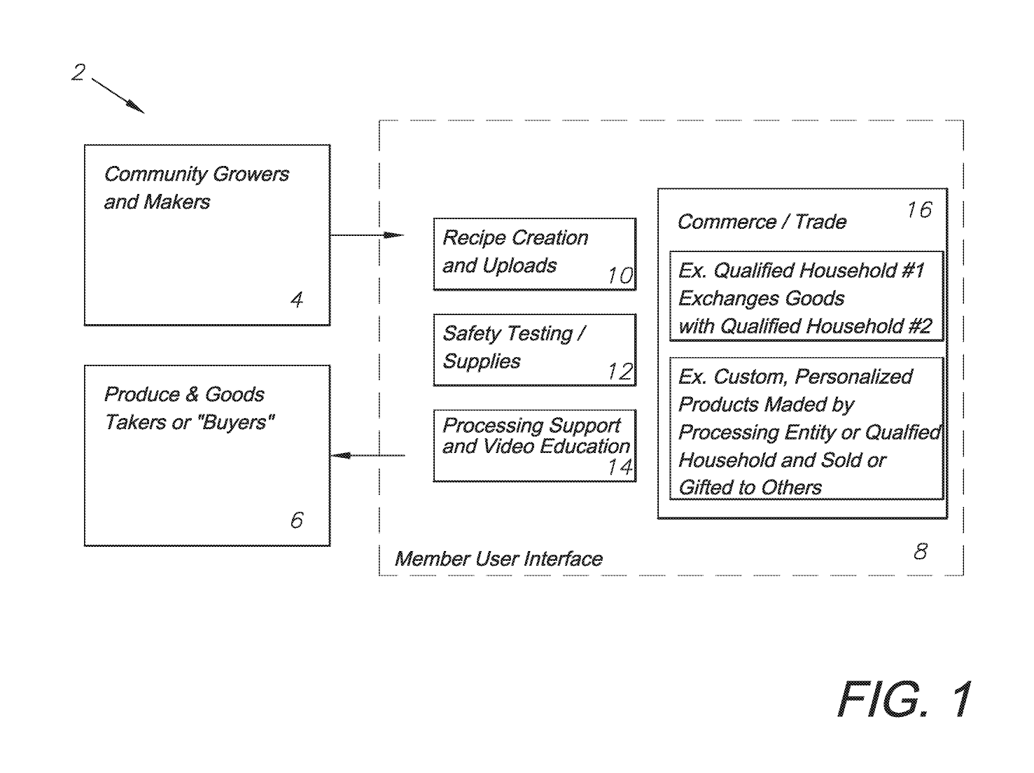

FIG. 1 shows a diagrammatic representation of several elements interacting within a product delivery system 2, which provides food or other consumer goods through a private network 26 to members within the network. As shown in FIG. 1, there is a member user interface 8 which is interacted with by the members of the product delivery system 2. Members may be made up of community growers and makers 4, which also may be referred to herein as “qualified households,” and of produce and goods takers or “buyers” 6. The qualified households 4 make goods, and the buyers 6 request the goods. However, there are a number of other exchanges of goods and services capable of being performed with this system.

As shown, the member user interface 8 includes recipe creation features 10 and uploads of recipes created by members, safety testing and supply 12 which can be provided by a central entity, third parties, or other members, and processing support and video education 14 which also would be handled by a central entity or third party. These features provide a typical buyer/seller relationship with quality control on the back end. Other features of the present invention include commerce/trade features 16, such as the examples shown in the box therein. Two members can exchange goods directly using the system, or can create products for mere buyer-members. The member user interface 8 likely is a computer interface, such as a touch screen smart kiosk, mobile computing device (e.g. smartphone, tablet computer) or a personal computer.

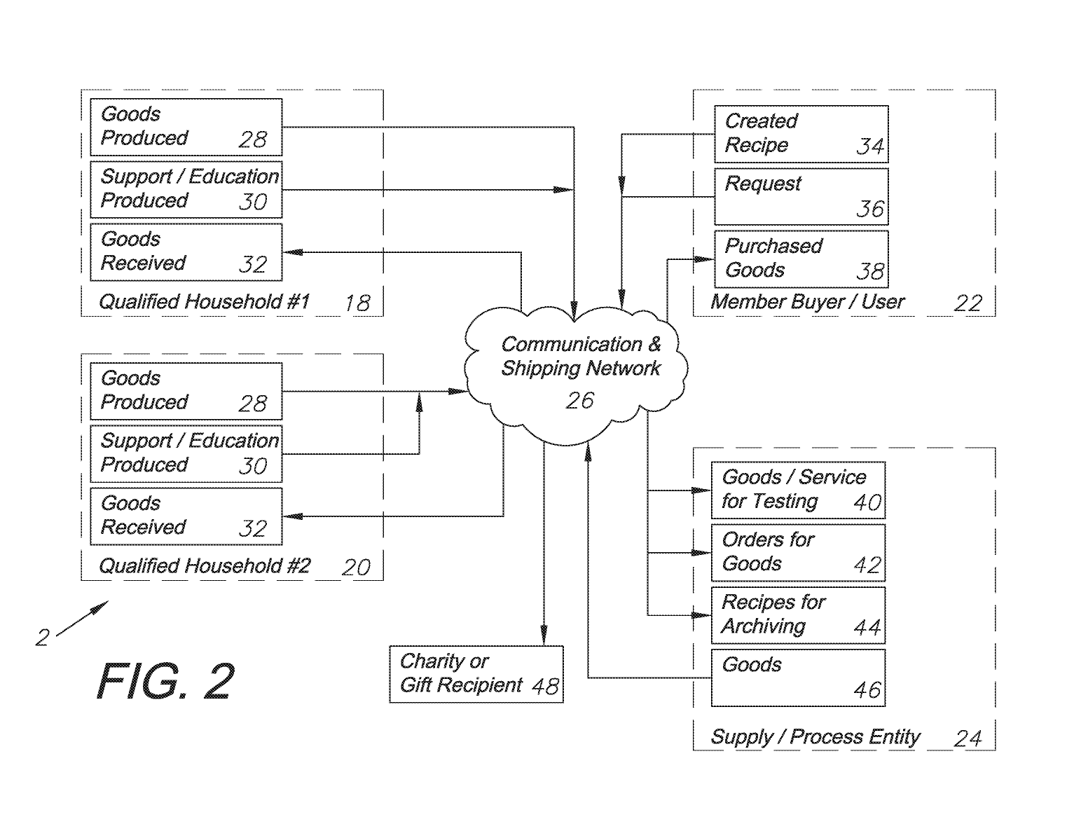

FIG. 2 diagrams the relationships between multiple parties through a communications and shipping network 26 which is the core of the product delivery system 2. Shown here are a qualified household #1 18, a qualified household #2 20, a member buyer/user 22, a supply/process entity 24, and a charity or gift recipient 48. Of course, more qualified households and members could be included. The qualified households 18, 20 are approved by a central entity, such as the supply/process entity 24, to make and ship goods, such as food items, using the communication and shipping network 26. Member buyer/users 22 have limited access to the network 26. The supply/process entity 24 mostly controls the network and approves and monitors goods and transactions, but may also fulfill orders. The charity or gift recipient 48 is an outside entity which may receive goods based upon a transaction within the network.

Each of the qualified households 18, 20 have both inputs into the network 26 and outputs coming out of the network as shown in FIG. 2. Each qualified household may produce goods 28, which may be traded with other qualified households or member buyers 22. These goods could include food items or other homemade goods, or may consist of new food items from a recipe submitted by a member buyer/user 22. The qualified households can also provide support/education productions 30, such as educational videos for preparing a food or other product (e.g. how to pickle foods). These can also be ordered out by other users. Finally, since the qualified households are also members, they can receive goods 32 through the network 26 either by purchasing or trading with other qualified households.

The member buyer/user 22, which would likely be the most common user for the system, can create recipes 34 which can be submitted to the network 26 and be fulfilled either by the supply/process entity 24 or any of the qualified households 18, 20. These recipes may then also be stored in an archive 44 with the supply/process entity for access by other members. The member can also request 36 goods, such as those advertised by the qualified households. Purchased goods 38 are then shipped directly to the member 22.

The supply/process entity 24 may also act as a central entity which owns and operates the entire delivery system 2. This entity receives goods and productions for testing 40 from qualified households and approves them or rejects them, receives orders for goods 42 from members, and receives the members' recipes for archiving 44. The supply/process entity may also supply goods 46 out to members, or may source this from third parties.

Members have an option to send a charity a copy of whatever they order through the network 26, or to send a gift to another person who may or may not be a member. These charity or gift recipients 48 receive the goods purchased by members or sent for free by a qualified household through the communication and shipping network 26. Goods shipped through the network 26 could be sent directly to the buyer or recipient in the mail or other door-to-door delivery method, or could be sent to a localized kiosk or delivery point for pickup by the recipient or buyer.

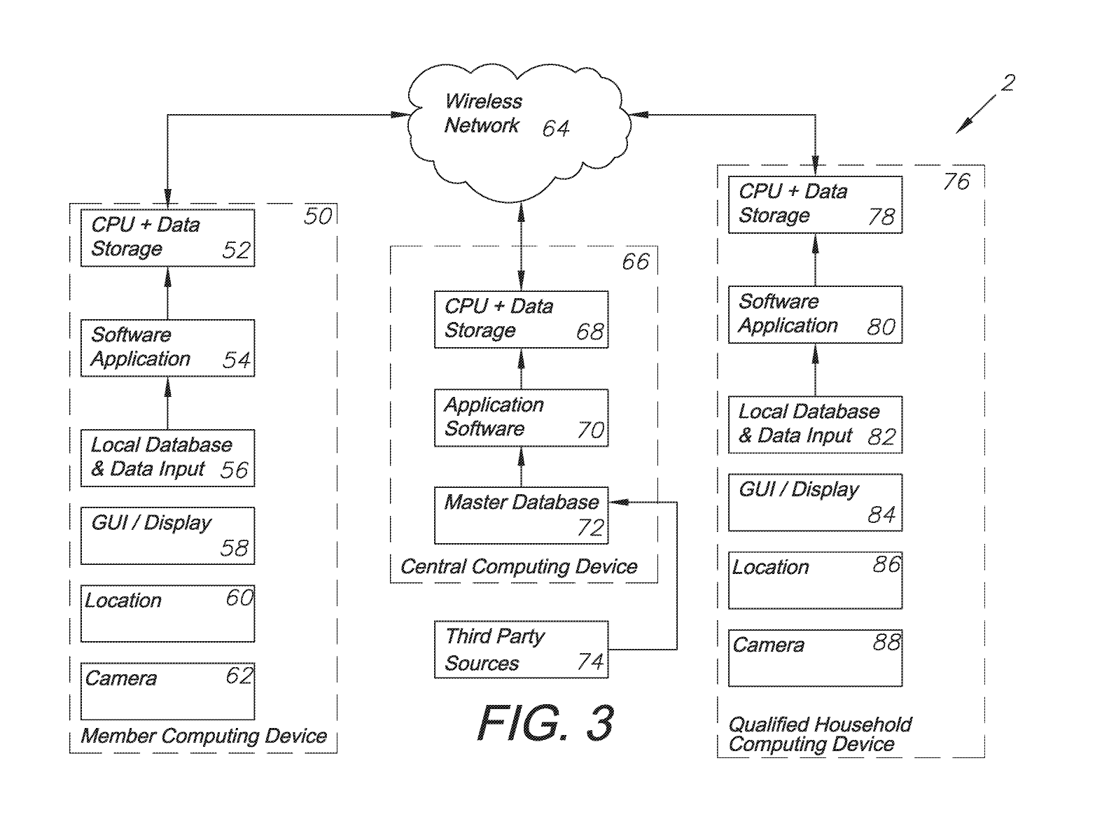

FIG. 3 shows another relationship between the members and the network. Here, each of the parties communicates through a wireless network 64 by using computing devices, which may include personal computers, mobile computing devices (e.g. smart phones), or proprietary smart kiosks. Here, the member computing device 50 includes CPU and Data storage 52, a software application 54 for accessing the product delivery system 2, and a local data base with data input 56 for creating customized recipes and orders. The device 50 should also include a graphical user interface (GUI) 58, a location determination feature 60, such as a GNSS like GPS, and a camera 62 for taking and uploading photographs of recipes or products.

Similarly, the qualified household computing device 76 includes CPU and Data storage 78, a software application 80 for accessing the product delivery system 2, and a local data base with data input 82 for creating customized recipes and orders. The device 76 should also include a graphical user interface (GUI) 84, a location determination feature 86, such as a GNSS like GPS, and a camera 88 for taking and uploading photographs of recipes or products.

The central computing device 66, which is a central server most likely associated with the supply/process entity 24, but could be a separate entity, houses the central point of the product delivery system 2. There is a CPU and data storage 68, application software 70 necessary to arrange the features of the system as described above, and a master database 72 which includes records of all purchases, recipes, educational videos, and other data uploaded to the central computing device 66. Third party sources 74 may also add data to the master database. These third parties may include product sources used by the supply/process entity to fulfill orders.

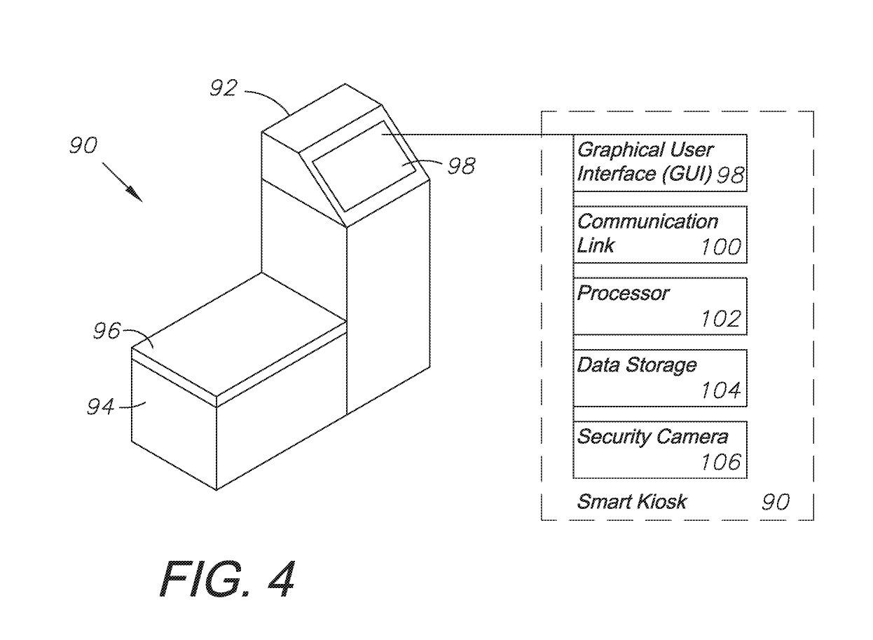

In lieu of every member having a mobile computing device or personal computer to access the network, smart kiosks 90, such as shown in FIG. 4, may be placed in geographically selected positions, such as near farmers markets or co-op stores. These kiosks would include a kiosk portion 92 which has a graphical user interface 98, communication link 100 (e.g. Wi-Fi or wired internet connection), processor 102, data storage 104, and optionally a security camera 106 to correctly identify members using the kiosk. The kiosk 90 may also include a secure drop-box portion 94 with an optional security lid 96 which requires passwords or identification to open. Here, users can drop off packages to be picked up by other members or postal service employees for shipment to buyers and other members.

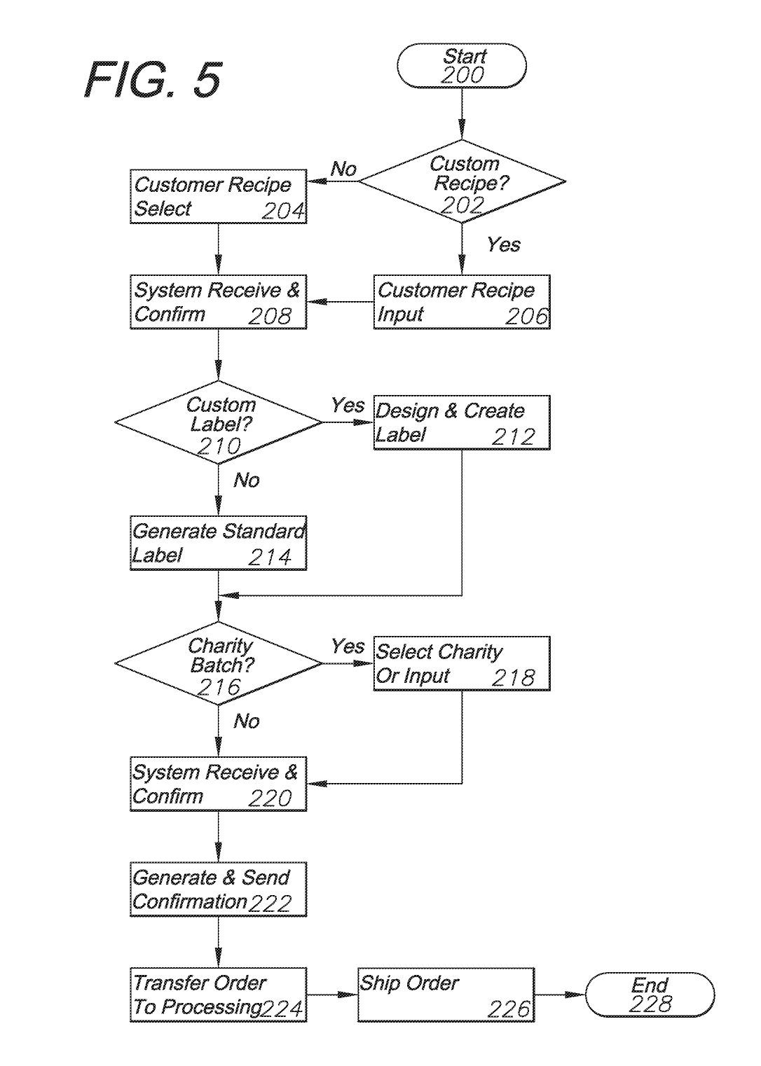

FIG. 5 shows a typical method of practicing the present invention, which starts at 200. A buyer or member will need to decide at 202 whether they will be ordering a custom recipe or an existing recipe. If a custom recipe is selected at 202, the user must then input the custom recipe at 206 into the system. Otherwise the user merely selects a recipe from a display at 204 from a list of existing recipes. The system will receive and confirm the selection of recipe at 208.

Next, the user must determine if they would like a customized label at 210. If yes, the user will design and create the label at 212, either by interacting with the graphical user interface of their selected computing device or smart kiosk, or by inserting or uploading a previously-created label. Otherwise, the user can select a standard label at 214, which may be selected from a list of preexisting labels.

The user will need to determine if they would also like to purchase a charity batch at 216. As described above, this charity batch would be an exact copy of the product they are ordering, but would be delivered for free to a charity or recipient of the user's choice. If the user decides to create a charity batch at 216, the user selects the charity and inputs its relevant data at 218. Otherwise the system receives and confirms the selection at 220, a confirmation is generated and sent to the user at 222, such as via email, and the order is transferred to processing at 224. The processing step here may send the request out to a qualified household or third party, but the result is that the product is made according to the specifications as entered in the kiosk, and then the product is packaged and shipped at 226 and the process ends at 228 with the user receiving their ordered product.

Additionally, users can create sharable recipe libraries and videos about their personalized and/or custom food-making for other users to watch and learn from.

The order is transmitted to the processing facility, which may be local to the ordering station (e.g. at the kiosk) or remote from the user. The processing facility could automatically generate the product from the recipe using machinery. Once the product is prepared, it is packaged and labeled and the selected quantities are sent to the user and to all other recipients selected by the user.

For orders transmitted, the user will build the product recipe from several category lists which includes ingredients or base components of the final product. This again would be done using a computerized interface as described above. After the product is designed by the user using the computerized interface, the steps continue as outlined above. This alternative embodiment provides a more simplified approach to providing a finished food product. Alternatively, for self-produced orders by qualified households, orders are made in accordance with documented recipe procedures as established within the system and as processed by the processing entity.

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. A communications and product ordering system comprising:
a communication portal comprising a processor, data storage, graphical user interface, and connection to wireless communications network;
a remote server comprising a processor, data storage, and connection to said wireless communications network, said data storage storing a database;
a first party associated with said communication portal, whereby said first party generates a request at said communications portal;
said request received at said remote server and analyzed by said processor of said remote server;
said request sent to a second party, said second party configured to respond to said request; and
whereby said request is fulfilled by said second party and delivered to said first party.

2. The system of claim 1, further comprising:
wherein said request is an order for a food product;
wherein said second party is configured to prepare said food product; and
whereby said food product is delivered to said first party.

3. The system of claim 2, further comprising:
said request comprises a recipe prepared by said first party and input into said communication portal by said first party;
said recipe stored in said database; and
said recipe viewable by a third party via a computing device comprising a processor, data storage, graphical user interface, and connection to said wireless communications network.

4. The system of claim 1, wherein said communications portal comprises a kiosk including a stand.

5. The system of claim 4, wherein said kiosk includes a storage compartment for delivery of said request.

6. A method of ordering a product, the method comprising the steps:
inputting a request into a communications portal, said communications portal comprising a processor, data storage, graphical user interface, and connection to wireless communications network;
sending said request to a remote server comprising a processor, data storage, and connection to said wireless communications network, said data storage storing a database;
processing said request at said remote server;
delivering said request to a fulfillment entity;
fulfilling said request at said fulfillment entity; and
delivering said request.

7. The method of claim 6, further comprising the steps:
wherein said request comprises an order for a food product; and
preparing said food product at said fulfillment entity.

8. The method of claim 7, further comprising the steps:
inputting a recipe at said communications portal as part of said request;
storing said recipe in said database; and
accessing said recipe with a third party computing device comprising a processor, data storage, graphical user interface, and connection to wireless communications network.

9. The method of claim 6, wherein said communications portal comprises a kiosk including a stand.

10. The method of claim 9, further comprising the steps:
delivering said request to a storage compartment connected to said kiosk;
confirming identity of a recipient; and
granting access to said storage compartment.

11. A method of requesting, generating, and delivering a customized food order, the method comprising the steps:
generating a request with a requesting party at a communications portal, said communications portal comprising a processor, data storage, graphical user interface (GUI), and connection to wireless communications network, and said request comprising a recipe for a food product;
sending said request to a remote server comprising a processor, data storage, and connection to said wireless communications network, said data storage storing a database;
processing said request at said remote server;
storing said recipe into said database;
authorizing a third-party fulfillment entity with said remote server processor;
delivering said request to a fulfillment entity;
preparing said food product at said fulfillment entity; and
delivering said food product to said requesting party, thereby fulfilling said request.

12. The method of claim 11, further comprising the steps:
said request comprising a duplicate food product order to be delivered to a gift recipient;
preparing said food product at said fulfillment entity; and
delivering said food product to said gift recipient, thereby fulfilling said request.

13. The method of claim 12, wherein said gift recipient is a charity.

14. The method of claim 11, wherein said communications portal comprises a kiosk including a stand.

15. The method of claim 14, further comprising the steps:
delivering said request to a storage compartment connected to said kiosk;
confirming identity of a recipient; and
granting access to said storage compartment.

16. The method of claim 15, further comprising the steps:
wherein said food product is a first food product;
wherein said requesting party is in possession of a second food product;
placing said second food product into said storage compartment;
retrieving and shipping said second food product;
retrieving and shipping said first food product;
placing said first food product into said storage compartment; and
thereby trading a quantity of said first food product for a quantity of said second food product.

17. The method of claim 11, further comprising the steps:
wherein said food product is a first food product;
wherein said requesting party is in possession of a second food product; and
trading a quantity of said first food product for a quantity of said second food product.
